(19) United States
(12) Patent Application Publication
(10) Pub. No.: US 2009/0124942 A1
(43) Pub. Date: May 14, 2009

(54) Massager

(76) Inventor: Costica Ungureanu, Thornhill (CA)

Correspondence Address: Mr. Costica Ungureanu, 16 Castle Harbour Lane, Thornhill, ON, L3T 3A2, CA

(21) Appl. No.: 11/979,765

(22) Filed: Nov. 8, 2007

(51) Int. Cl. A61H 15/00

(52) U.S. Cl. 601/137

(57) ABSTRACT

A massager comprises a massage tool for application of massage, and a support for supporting the massage tool. For respective dispositions of the massager, the massage tool and the support are shaped and configured for the massage tool to be selectively supportable by, and removable from, the support.

### BACKGROUND OF THE PRESENT INVENTION

The present invention pertains to a massager, and especially to a massager in which respective dispositions of the massager are possible.

### SUMMARY OF THE PRIOR ART

Prior art is apparently only general background to the present invention.

For example, as compared to what is disclosed in Canadian Patents 1,055,542, 1,101,285, and 1,245,926, the present invention more readily facilitates respective dispositions of a massager.

### SUMMARY OF THE INVENTION

Disadvantages of prior art massagers, and especially of respective dispositions of those massagers, may be overcome according to the present invention. For example, the present invention provides for four respective dispositions of the massager: massage through using the massager as a whole; massage through taking a massage tool out of the massager; removing or replacing components of the massage tool; and cleaning some or all of the massager through taking the massage tool out of the massager.

According to the present invention, there is provided a massager comprising
massage-tool means for application of massage and
support means for supporting said massage-tool means;
   and wherein, for respective dispositions of said massager, said massage-tool means and said support means are shaped and configured for said massage-tool means to be selectively supportable by, and removable from, said support means.

### BRIEF DESCRIPTION OF THE DRAWINGS

In drawings which illustrate embodiments of the invention,

FIG. 1 is a perspective view from above, of an embodiment of the massager according to the invention;

FIG. 2 is a perspective view from below, of the support means of the embodiment shown in FIG. 1;

FIG. 3 is a partially exploded perspective view from above, of the embodiment shown in FIG. 1;

FIG. 4 is perspective view of one of the cogged wheels shown in FIGS. 1 and 3;

FIG. 5 is a perspective view from above, of an inner component of a massage-tool means according to the invention;

FIG. 6 is perspective view from above, of a largely interior component of a massage-tool means according to the invention;

FIG. 7 is a partially exploded perspective view from above, of the massage-tool means depicted in FIGS. 1 and 3;

FIG. 8 is a perspective view from below, of a disassembly tool for use on the largely interior component especially depicted in FIGS. 6 and 7; and

FIG. 9 is a partially exploded perspective view from below, of the massage-tool means depicted in FIGS. 1, 3, and 7, with the disassembly tool depicted in FIG. 8.

### DETAILED DESCRIPTION OF THE PREFERRED EMBODIMENT

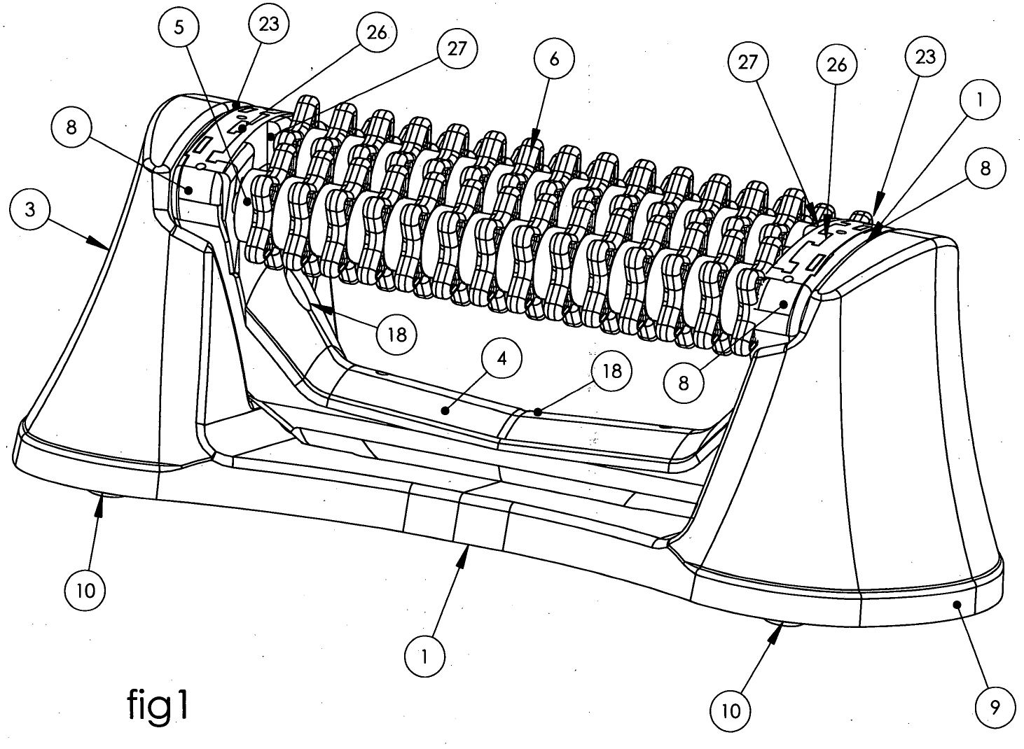

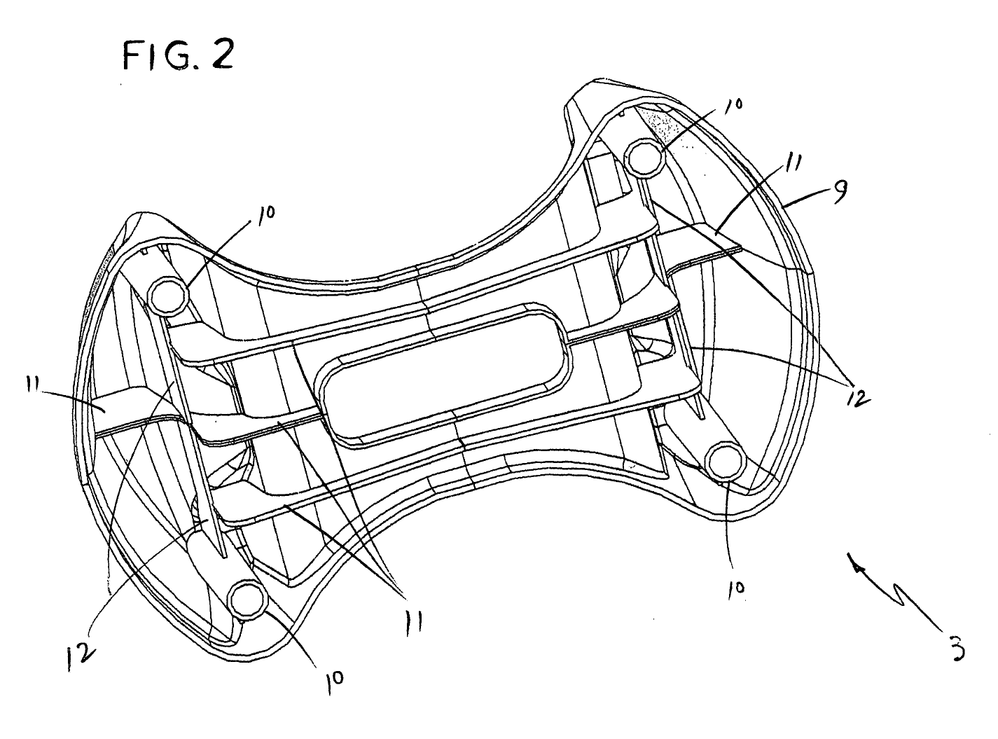

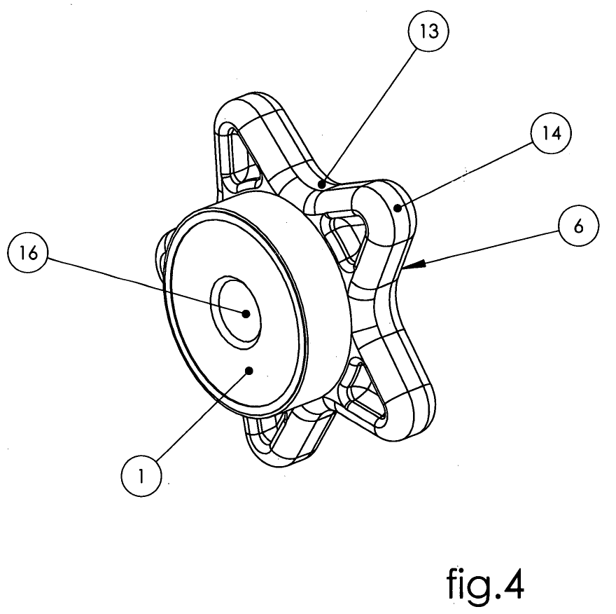

Referring to FIGS. 1 through 9, construction and use of the preferred embodiment of the massager according to the invention will now be described.

Referring to FIGS. 1 through 3, massager 1 comprises massage-tool means 2 for application of massage, and support means 3 for supporting massage-tool means 2.

Massage-tool means 2 comprises handle means 4 and releasably-securable axle-mounted massage-application contact means 5 such as cogged disks 6.

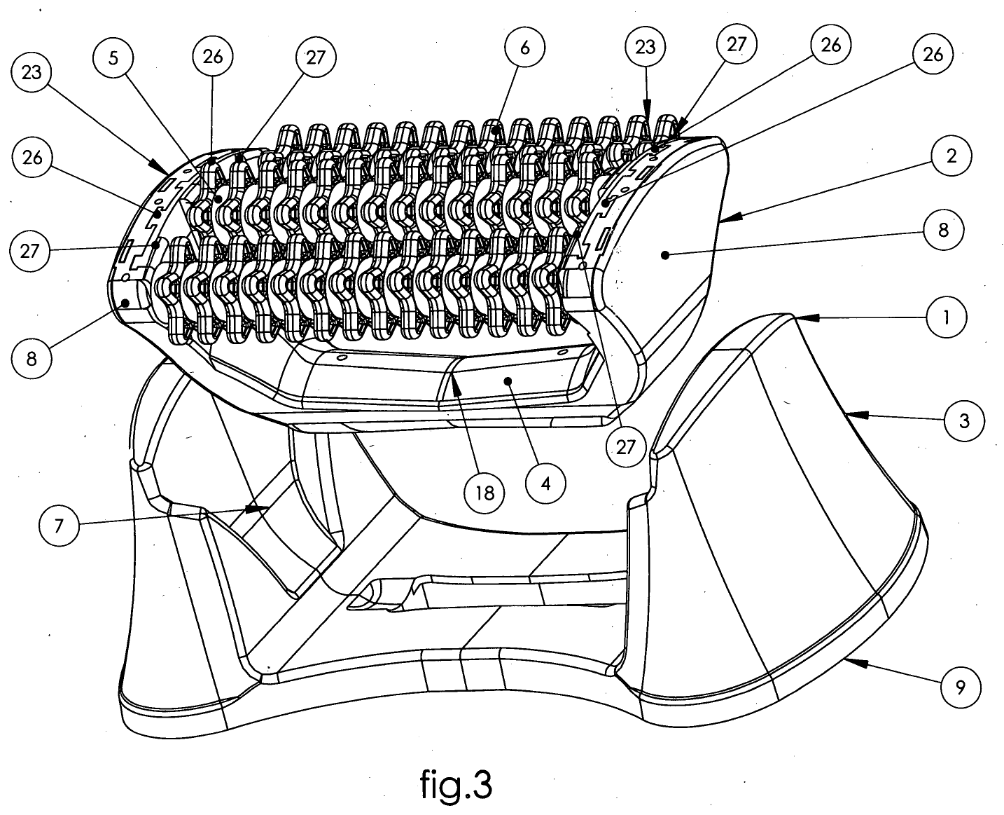

As is especially shown in FIGS. 1 and 3, for respective dispositions of massager 1, massage-tool means 2 and support means 3 are shaped and configured for massage-tool means 2 to be selectively supportable by, and removable from, support means 3. More specifically, support means 3 for supporting massage-tool means 2 comprises gap means 7 and massage-tool means 2 comprises a surface 8 corresponding to gap means 7. Gap means 7 converges downwardly along support means 3, comprises curvilinear gap means having a side defined by an arm of a parabola and, indeed, comprises curvilinear gap means having two such sides that are symmetric to one another.

As is shown in FIGS. 1, 3, and especially 2, support means 3 comprises stabilizing means. More specifically, support means 3 comprises a skirt 9, a plurality of posts 10, a plurality of ribs 11, and a plurality of struts 12. Skirt 9 extends away from massager 1. Plurality of ribs 11 is perpendicular to prospective directions of the application of massage. Plurality of struts 12 comprises individual struts on respective sides of the massager 1, joining a pair of posts 10 that are on that same side of the massager 1 and being parallel to prospective directions of the application of massage.

As is shown in FIGS. 1, 3, and especially 4, each of the cogged disks 6 comprises a five-point star-shaped laminar member 13 having rounded points 14; a right-circular cylindrical laminar member 15 integral with, parallel to, and symmetric about the laminar member 13; and a right-circular cylindrical opening 16 through the center of each of the laminar member 13 and the laminar member 15. The laminar member 13 and the laminar member 15 are each shaped and configured so that the rounded points 14 of immediately adjacent rows of cogged disks 6 can be spaced apart from one another such that the rounded points 14 of immediately adjacent rows of cogged disks 6 will not interfere with one another. Preferably, the laminar member 13 and the laminar member 15 are each 5 millimeters thick and made of polypropylene (commonly referred to as “PP”) plastic and are mounted on three rods (not shown). Depending on the length of each rod (not shown), there are ten to fifteen cogged disks 6 per rod (not shown). Preferably, each of the three rods (not shown) is of T-302 stainless steel, is between 155 and 165 millimeters in length, and has an outside diameter of 4 millimeters.

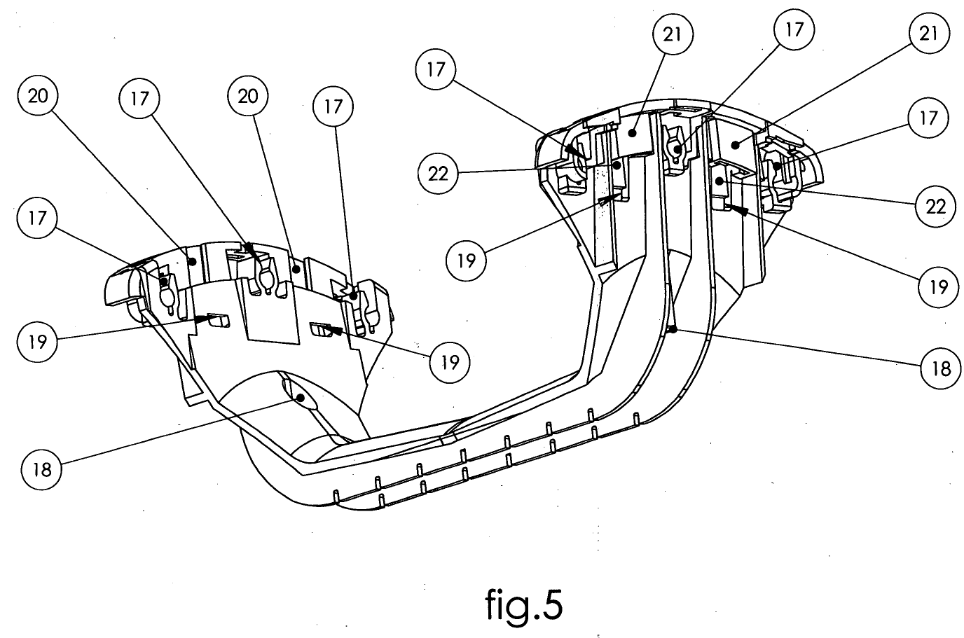

Other parts of the massager 1 are preferably made by injection molding of a thermoplastic that combines the strength and rigidity of acrylonitrile and styrene polymers with the toughness of polybutadiene rubber. Acrylonitrile butadiene styrene (commonly referred to as “ABS”), is such a material, such that support means 3 is ABS and has walls at least 2 millimeters thick and such that handle means 4 is ABS and generally has walls at least 1.5 millimeters thick. As shown in FIG. 5, wall thickness of an inner component of the handle means 4 is greater than 1.5 millimeters in each region 17 around the ends of each of the three rods (not shown) and in each region 18 around where each of three screws (not shown) is to join an inner and an outer component of the handle means 4 to one another once those two components are fitted together. As also shown by FIG. 5, each end of an inner component of a massage-tool means 2 has two rectangular openings 19 through it; above and aligned with each rectangular opening 19 there is a respective channel 20 which has a rectangular cross-section, which at its upper end is partly enclosed by a bracket 21, and which has a lower end 22 beveled interiorly towards an outer component of a massage-tool means 2 and downwardly towards the rectangular opening 19.

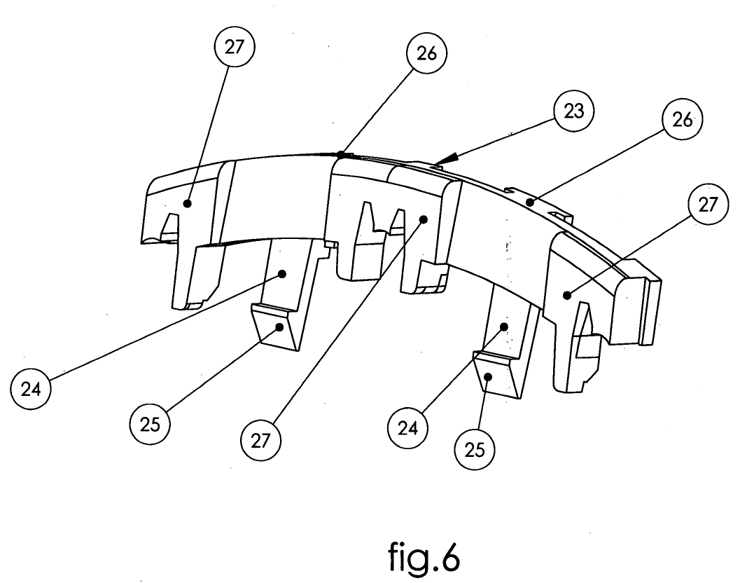

As shown by FIG. 6, a largely interior component 23 of a massage-tool means 2 has two prongs 24. Each prong 24 has at its lower end a beveled tooth 25. Each beveled tooth 25 is to be flexed into interior space between the inner component of the handle means 4 and the outer component of the handle means 4. Such flexing is to be by a lower end 22 of a channel 20: when a prong 24 is inserted downwardly through the upper end of a bracket 21, then out of the bottom of that bracket 21, and then farther along a channel 20, the flexing occurs by the beveled tooth 25 contacting and being pushed interiorly by the lower end 22 of a respective channel 20. Each beveled tooth 25 is also shaped and configured such that when the largely interior component 23 is pushed down farther, the beveled tooth 25 then securely snaps into a respective rectangular opening 19. Each prong 24 also has a protrusion 26 which is shaped and configured to securely fit inside a respective bracket 21. As well, each rod-securing protrusion 27 of largely interior component 23 is shaped and configured to securely fit a corresponding inner face of each region 17 around the ends of a respective one of the three rods (not shown) so as to secure each of the three rods (not shown).

As shown by FIGS. 5 and 6, releasably-securable means for securing the axle-mounted massage-application contact means 5, comprises a tongue-and-groove join of an inner component of said massage-tool means 2 and a largely interior component 23 of said massage-tool means 2: a region 17, rectangular opening 19, channel 20, bracket 21, lower end 22, prong 24, beveled tooth 25, protrusion 26, and rod-securing protrusion 27.

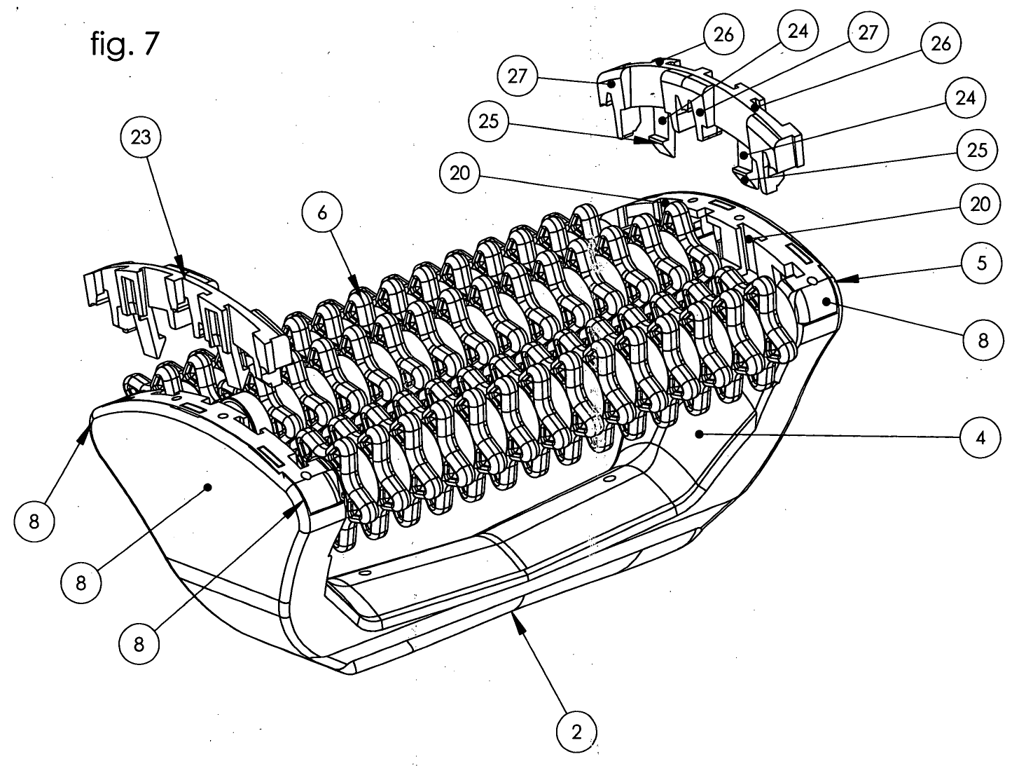

As shown by FIG. 7, at each end of massage-tool means 2 a respective largely interior component 23 depicted in FIG. 6 is to be slid into place in the manner described in the two immediately preceding paragraphs hereof (Of the two largely interior components 23 depicted in FIG. 7, only the depiction of the largely interior component 23 in the right-hand side of FIG. 7 has element numbers applied to it, as the depiction of the largely interior component 23 in the left-hand side of FIG. 7 is not amenable to having element numbers applied to it.)

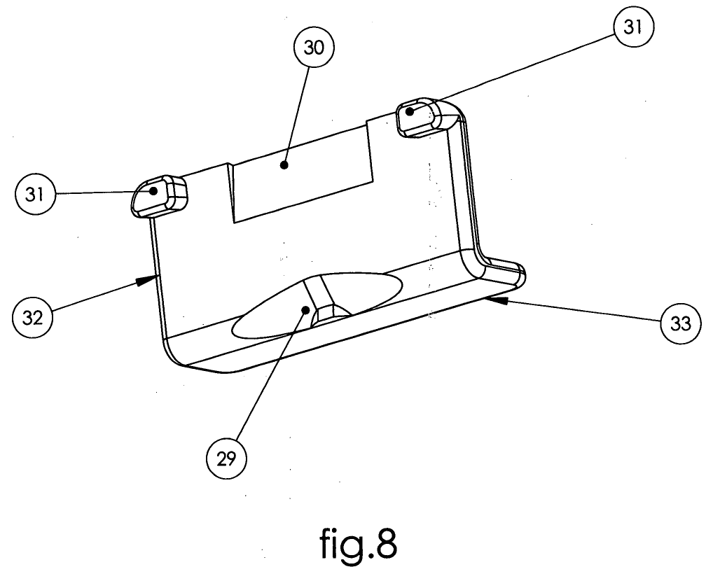

As shown by FIG. 8, a disassembly tool 28 for use on the largely interior component 23 depicted in FIGS. 6 and 7, has an upper member 32, has a lower member 33, and is of a generally L-shaped cross-section. The outer face of the disassembly tool 28 has a concavity 29 which is between the upper member 32 and the lower member 33, and which is shaped and configured to conform to the inner surface of the handle 4. The outer face of the disassembly tool 28 also has a wedge-like opening 30 which is shaped and configured to conform to the lower part of the central one of the regions 17 of the handle 4. As well, the outer face of the disassembly tool 28 has two protrusions 31 each of which is shaped and configured to be inserted into a respective rectangular opening 19.

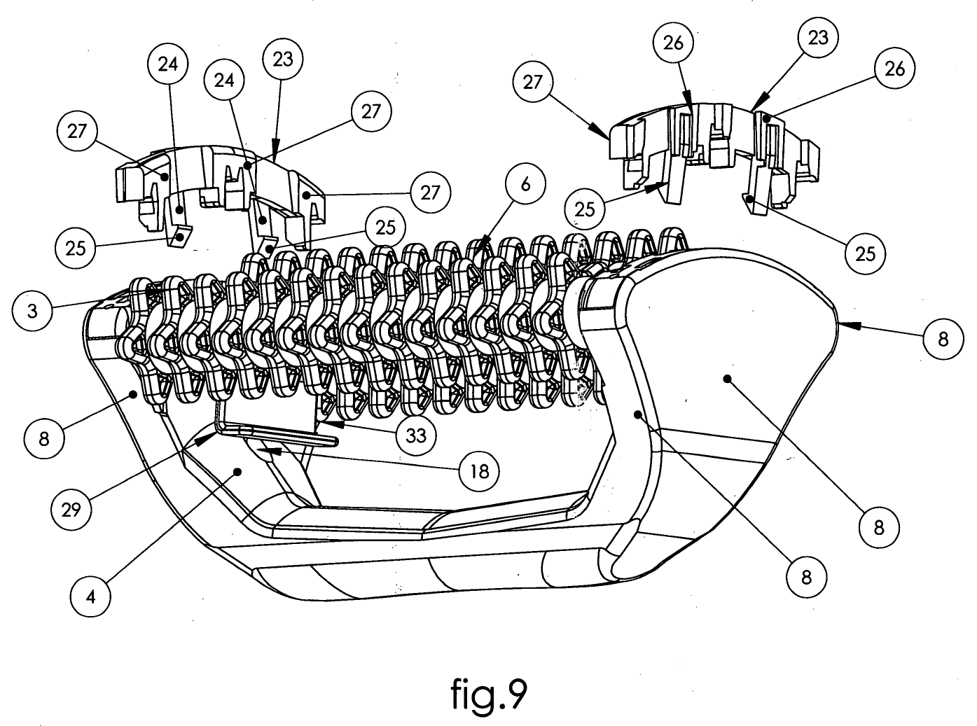

As shown by FIG. 9, by placing the disassembly tool 28 on the massage-tool means 2 such that the concavity 29 conforms to the inner surface of the handle 4, such that the wedge-like opening 30 conforms to the lower part of a respective central one of the regions 17 of the handle 4, and such that each of the two protrusions 31 is inserted into a respective rectangular opening 19, and by then sufficiently rotating the tool 28 about the region between the upper member 32 and the lower member 33, each of the of two protrusions 31 advances farther into the respective rectangular openings 19 such that each respective beveled tooth 25 is disengaged from its respective rectangular opening 19. Each largely interior component 23 can then be removed accordingly. Once both largely interior components 23 have been removed then any or all of the three rods (not shown) and the cogged disks 6 that are on them can be removed in order to clean some or all of the cogged disks 6, or to remove or replace cogged disks 6 such as with other cogged disks (not shown) having a different number or shape of points. Once such cleaning (or removal or replacement) has been completed, and releasably-securable axle-mounted massage-application contact means 5 such as cogged disks 6 and rods (not shown) have been put into the massage-tool means 2, each of the largely interior components 23 can then be reinserted and snapped back into place, in analogy with what is described in connection with FIG. 6.

Preferably, the lower end of each of the posts 10 is capped by a knob (not shown) made of a thermoplastic polymer such as polyvinyl chloride (commonly referred to as “PVC”).

The four respective dispositions (or multi-use aspects) of the massager 1, which are referred to above, will now be more readily apparent. Massage through using the massager 1 as a whole, can especially be effected on the soles of the feet of a seated user of the massager 1 by setting the support means 3 of massager 1 on a floor and by the user then applying the soles of the user's feet to the rounded points 14 of the cogged disks 6, to cause the cogged disks 6 to rotate about each of the three rods (not shown). Massage through taking the massage-tool means 2 out of the support means 3 of the massager 1, can be effected on a variety of body parts of a user or of another, by lifting the massage-tool means 2 out of the support means 3 of the massager 1 and by the user then applying the rounded points 14 of the cogged disks 6 to such body parts, to cause the cogged disks 6 to rotate about each of the three rods (not shown). Removing or replacing components of the massage-tool means 2, can especially be effected through removing both largely interior components 23, then removing and replacing releasably-securable axle-mounted massage-application contact means 5 such as cogged disks 6 and rods (not shown), and then reinserting each of the largely interior components 23 and snapping each of the largely interior components 23 back into place. Cleaning some or all of the massager 1 through taking the massage-tool means 2 out of the support means 3 of the massager 1 can especially be effected by lifting the massage-tool means 2 out of the support means 3 of the massager 1 and by rinsing either or both of the support means 3 and the cogged disks 6 with water; indeed, the materials used to construct the massager 1 also facilitate using the massager 1 in water.

The claimed embodiments of the present invention are as follows:

1. A massager comprising
massage-tool means for application of massage and
support means for supporting said massage-tool means;
and wherein, for respective dispositions of said massager, said massage-tool means and said support means are shaped and configured for said massage-tool means to be selectively supportable by, and removable from, said support means.

2. A massager as claimed in claim 1, wherein said shaped and configured support means comprises gap means and said shaped and configured massage-tool means comprises a surface corresponding to said gap means.

3. A massager as claimed in claim 2, wherein said gap means comprises gap means converging downwardly along said support means.

4. A massager as claimed in claim 3, wherein said downwardly converging gap means comprises curvilinear gap means.

5. A massager as claimed in claim 4, wherein said curvilinear gap means comprises gap means having a side defined by an arm of a parabola.

6. A massager as claimed in claim 5, wherein said gap means having a side defined by an arm of a parabola comprises two such sides.

7. A massager as claimed in claim 6, wherein said two such sides are symmetric to one another.

8. A massager as claimed in claim 7, wherein said massage-tool means comprises handle means.

9. A massager as claimed in claim 8, wherein said support means comprises stabilizing means.

10. A massager as claimed in claim 9, wherein said stabilizing means comprises a skirt extending away from said massager.

11. A massager as claimed in claim 9, wherein said stabilizing means comprises a plurality of posts.

12. A massager as claimed in claim 9, wherein said stabilizing means comprises a plurality of ribs perpendicular to prospective directions of said application of massage.

13. A massager as claimed in claim 9, wherein said stabilizing means comprises a plurality of struts parallel to prospective directions of said application of massage.

14. A massager as claimed in claim 10, wherein said stabilizing means comprises a plurality of posts.

15. A massager as claimed in claim 10, wherein said stabilizing means comprises a plurality of ribs perpendicular to prospective directions of said application of massage.

16. A massager as claimed in claim 10, wherein said stabilizing means comprises a plurality of struts on respective sides of said massager, joining a pair of posts that are on that same side of said massager and being parallel to prospective directions of said application of massage.

17. A massager as claimed in claim 9, wherein said stabilizing means comprises
a plurality of posts;
a plurality of ribs perpendicular to prospective directions of said application of massage; and
a plurality of struts parallel to prospective directions of said application of massage.

18. A massager as claimed in claim 17, wherein said stabilizing means comprises a skirt extending away from said massager.

19. A massager as claimed in claim 18, wherein said massage-tool means comprises axle-mounted massage-application contact means.

20. A massager as claimed in claim 19, wherein said axle-mounted massage-application contact means is releasably-securable.

21. A massager as claimed in claim 20, wherein said releasably-securable axle-mounted massage-application contact means is releasably-securable as a result of said massage-tool means comprising releasably-securable means for securing said axle-mounted massage-application contact means.

22. A massager as claimed in claim 21, wherein said releasably-securable means for securing said axle-mounted massage-application contact means comprises a tongue-and-groove join of an inner component of said massage-tool means and a largely interior component of said massage-tool means.

23. A massager as claimed in claim 22, wherein said axle-mounted massage-application contact means comprises three rods.

24. A massager as claimed in claim 23, wherein said axle-mounted massage-application contact means comprises cogged disks.

25. A massager as claimed in claim 24, wherein each of said cogged disks comprises
a five-point star-shaped laminar member having rounded points;
a right-circular cylindrical laminar member integral with, parallel to, and symmetric about said five-point star-shaped laminar member; and
a right-circular cylindrical opening through the center of each of said five-point star-shaped laminar member and said right-circular cylindrical laminar member.

26. A massager as claimed in claim 25, wherein said five-point star-shaped laminar member and said right-circular cylindrical laminar member are each shaped and configured so that said rounded points of immediately adjacent rows of said cogged disks can be spaced apart from one another such that said rounded points of immediately adjacent rows of cogged disks will not interfere with one another.
